(19) United States
(12) Patent Application Publication
(10) Pub. No.: US 2010/0096378 A1
(43) Pub. Date: Apr. 22, 2010

(54) Heating Device For Condensate Trap

(75) Inventors: Thomas Baur, Weilheim (DE); Wolfgang Maurer, Holzgerlingen (DE); Dietmar Mirsch, Kirchheim (DE); Hans-Joerg Schabel, Oberboihingen (DE); Klaus Scherrbacher, Deggingen (DE)

Correspondence Address: CROWELL & MORING LLP;INTELLECTUAL PROPERTY GROUP, P.O. BOX 14300, WASHINGTON, DC, 20044-4300, US

(73) Assignees: Daimler AG, Stuttgart (DE); Ford Global Technologies, LLC, Dearborn, MI (US)

(21) Appl. No.: 12/620,281

(22) Filed: Nov. 17, 2009

Related U.S. Application Data
(63) Continuation of application No. PCT/EP2008/003215, filed on Apr. 22, 2008.

(30) Foreign Application Priority Data
May 18, 2007 (DE) 10 2007 023 417.3

(51) Int. Cl. H05B 1/00

(52) U.S. Cl. 219/209; 219/540

(57) ABSTRACT

A device which ensure functionality of a vehicle fuel cell system, even at temperatures of below freezing point, includes at least one heating element arranged in the area of the condensate trap of the fuel cell in such a way that any ice present is heated locally. As a result, one or more melted channels form, through which water may flow after only a very short thawing process.

This application is a continuation of PCT International Application No. PCT/EP2008/003215, filed Apr. 22, 2008, which claims priority under 35 U.S.C. §119 to German Patent Application No. 10 2007 023 417.3, filed May 18, 2007, the entire disclosure of which is herein expressly incorporated by reference.

The invention relates to devices for operating fuel cells in vehicles. In particular, the invention relates to components which ensure functionality of a fuel cell system even at temperatures below the freezing point.

Fuel cells convert chemical energy into electrical energy. Increasingly wide use is currently being made of fuel cells for mobile and stationary energy supply. In particular, the development of electrically operated motor vehicles is being promoted for environmental reasons.

At the moment there are various types of fuel cells in existence, their working principle generally being based on the electrochemical recombination of hydrogen and oxygen to yield water as the final product. They may be classified on the basis of the type of conductive electrolytes used, the operating temperature level and the power ranges achievable. Polymer electrolyte membrane (PEM) fuel cells are particularly suitable for automotive applications. In such a PEM fuel cell the electrochemical reaction of hydrogen with oxygen to yield water is separated into the two partial reactions of oxidation and reduction by the insertion of a proton-conducting membrane between the anode and cathode electrodes. PEM cells are conventionally operated at a temperature in the range of from 50° C. to 90° C.

Fuel cells of modern design have special constructional requirements for operation in vehicles, in order to be suitable for use under different weather conditions. In particular, it is necessary to control the water balance in a PEM fuel cell. Water is produced in the cell as a result of the electrochemical reaction and removed from the cell as liquid or vapor by generally known devices. The steam in the outlet streams is partially recovered by passing the exhaust air through a condenser, in order to cool the exhaust air, resulting in the formation of condensate. The condensate is collected and fed to the fuel cell system as required, or is drained away to the surrounding environment. Such a device is described for example in German patent document DE 10204124 A1. Ideally, the loss of water evaporated in the cell and drained off through the process ventilation systems is compensated by the production of water as a secondary product of the chemical reaction taking place in the cell stack minus the water necessary for fuel processing.

FIG. 1 is a schematic representation of the air supply in appropriately equipped PEM systems according to the current prior art. The fresh air is first compressed in the compressor (1) and then cooled back down in the charge air cooler (3) by means of cooling water. As the process continues, the air flows into the humidifying module (4), in which it absorbs steam from the waste gas of the fuel cell (6) via membranes (5). Moisture content can be adjusted using the bypass (7) around the humidifier. Then the air is passed into the fuel cell (6) and there takes part in the electrochemical reaction. After the reaction, any liquid water present is separated from the waste gas stream by the condensate separator (8) and the remaining waste gas is fed back to the humidifier module (4), where it outputs steam to the fresh gas via the membranes (5). Downstream of the humidifier module, the waste gas is depressurized in the turbine (2) and released into the surrounding environment.

Motor vehicles are exposed to different weather conditions. When traveling in the winter at temperatures below freezing point, water could for example freeze in the condensate separator or the downstream areas. Published German patent application DE 101 10 419 A1 accordingly describes a fuel cell system in which an additional water supply at a higher temperature may if required be connected by means of valve control into the main water circuit for heating purposes, for example at a temperature of less than 3° C. This arrangement requires an additional water storage means with corresponding lines and valve controllers, which is disadvantageous with regard to weight and manufacturing complexity. Under cold start conditions at temperatures of below 0° C. rapid liquefaction of the frozen quantity of water is barely possible, with ultimately even the auxiliary water circuit in turn being frozen.

With a somewhat different objective, German patent document DE 10 2004 051 542 A1 describes an electrical heating unit for fuel cells. The priority here is dynamic response behavior, in particular even in the case of a cold start for a fuel cell. In this respect, a metallic pipe filled with liquid is connected as part of a closed secondary winding of a transformer and thus is heated electrically. To heat the fuel cell water circuit, either the pipe has reaction water flowing directly through it or it is part of a secondary circuit containing another medium, for example glycol, by means of which the reaction water is then first heated. Because with this arrangement only a portion of pipe is electrically heated, although rapid heating may be achieved in this area the entire area of the water circuit (frozen into ice) is thawed only gradually thereafter.

The stated devices therefore have the disadvantage under cold start conditions at temperatures of markedly below 0° Celsius that in particular the ice located in the area of the condensate separator of the fuel cell is liquefied only little by little, with this important assembly becoming functional only thereafter.

One object of the present invention, which is based on the above-cited German patent document DE 10 2004 051 542 A1 as the closest prior art, is to provide a device for accelerating the thawing process in particular in a fuel cell condensate trap.

This and other object sand advantages are achieved by the invention, in which one or more electrical heating elements are arranged in particular in the area of a condensate trap in such a way that any ice present is heated locally, forming one or more melted channels through which water may flow after only a very short thawing process. This ensures that the reaction water can flow away at a very early point, since it is not necessary for all the ice present to be melted.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic depiction of a PEM fuel cell system according to the prior art;

FIG. 2 is a schematic depiction of a local heating element arranged within a fuel cell component according to the invention;

FIG. 3 is a schematic depiction of a heater and heat conducting elements according to the invention, arranged within a fuel cell component; and

FIG. 4 is a schematic perspective view of two parallel fins heated by a heating element, within a condensate separator.

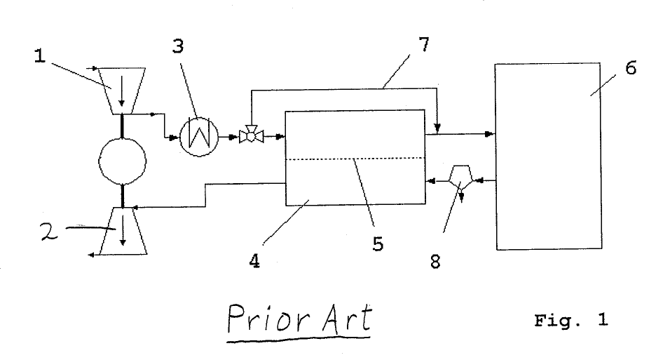

### DETAILED DESCRIPTION OF THE DRAWINGS

When starting a fuel cell system, it is important for circulation through the water circuit to be achieved as rapidly as possible. Ice present in the condensate separator prevents this process until a first through-flow channel has formed in the ice as a result of heating. As the fuel cell reaction starts, corresponding heat of reaction arises therein and, as water flow begins, the channel in the frozen-up area of the condensate trap is rapidly widened as a result of warm reaction water and finally the ice present is completely dissolved.

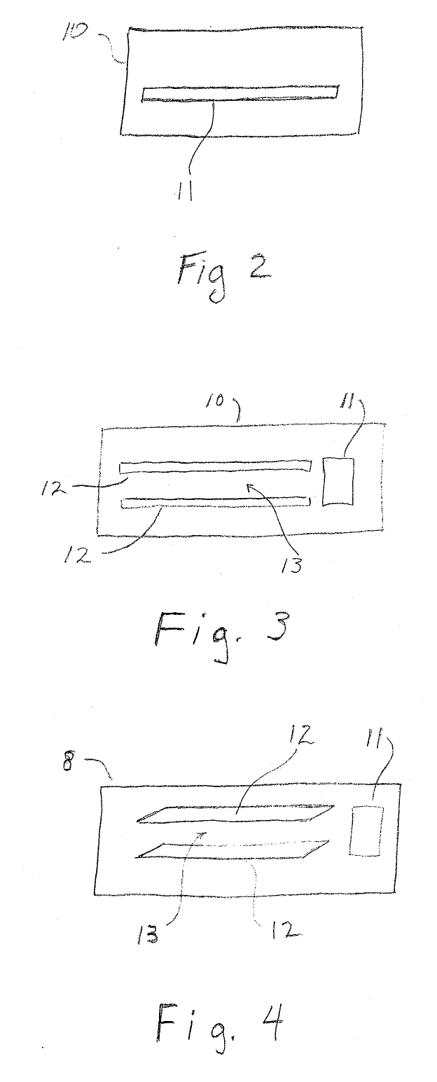

To heat the ice locally, and thereby to produce a first through-flow channel, the present invention provides at least one heating element 10, arranged within a fuel cell component 11, as shown schematically in FIG. 2. The heating element(s) 10 may itself be of elongate shape, or may be associated with one or more correspondingly shaped heat-conducting elements 12, preferably made of metal, such as for example copper or aluminum. (FIG. 3.) For example, the heat conducting elements 12 may be provided in the form of two metal fins heated by one or more heating elements, and arranged in parallel in the area of the condensate separator 8, such that ice located in an area 13 between them, melts rapidly upon heating and a through-flow channel thus arises. (FIG. 4.)

If such a heating arrangement is fitted for example vertically, a correspondingly vertical channel forms, through which the melted water may flow away simply due to the effect of gravity, so that, even with relatively small amounts of heating energy, water circulation may thus start. In contrast, electrical heating of the entire area of an iced-up condensate trap would take significantly longer.

Examples of electrical heating elements which are suitable for the device according to the invention include PTC thermistors. These are available in different shapes, sizes and heating powers, and may be adapted to respective conditions through the provision of heating fins.

In a further embodiment of the device according to the invention, it is also possible to use a combination of differently constructed heating elements. In this way, heating processes may be adapted to the structural geometry of different fuel cell components. It is also possible to heat individual zones selectively or indeed in sequence; for example, higher priority may be given to opening up valves, then any measuring instruments (e.g., level sensors) may be bought up to a functional temperature, after which filter areas may be thawed for the purpose of through-flow.

The device according to the invention markedly accelerates cold starting of a fuel cell system in a vehicle even at low temperatures below freezing point. The partial heating of preferred zones of individual components of the fuel cell system additionally means that only a relatively low heating power and a correspondingly reduced amount of current is required during the start phase.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Apparatus for heating a component of a fuel cell system, said apparatus comprising:
at least one electrical heating element for liquefying ice that is present in said component;
wherein said at least one electrical heating element is arranged locally within said component in such a way that, upon heating, a localized melted water channel forms in ice present in proximity to said at least one electrical heating element within said component.

2. The apparatus according to claim 1, wherein:
said at least one electrical heating element comprises heat-conducting elements in the form of metallic fins; and
said metallic fins extend in parallel within said component, such that a melted water channel forms therebetween upon heating.

3. The apparatus according to claim 1, wherein a plurality of local electrical heating elements, with respective different heating powers, are arranged in different areas of said component.

4. The apparatus according to claim 1, wherein said electrical heating elements are combined into functional groups for heating different components of the fuel cell system.
